(19) United States
(12) Patent Application Publication
(10) Pub. No.: US 2026/0200284 A1
(43) Pub. Date: Jul. 16, 2026

(54) THERMAL MANAGEMENT SYSTEM FOR AN ELECTRICALLY OPERATED MOTOR VEHICLE

(71) Applicant: Schaeffler Technologies AG & Co. KG, Herzogenaurach (DE)

(72) Inventors: Benedikt Grubauer, Neresheim (DE); Simon Ortmann, Pulheim (DE)

(73) Assignee: Schaeffler Technologies AG & Co. KG, Herzogenaurach (DE)

(21) Appl. No.: 19/133,229

(22) PCT Filed: Nov. 8, 2023
(86) PCT No.: PCT/DE2023/100835

§ 371 Date: May 28, 2025

(30) Foreign Application Priority Data
Nov. 28, 2022 (DE) 10 2022 131 333.6

(51) Int. Cl. B60H 1/00; B60L 58/24; B60T 5/00

(52) U.S. Cl. CPC B60H 1/00392; B60H 1/00278; B60L 58/24; B60T 5/00

(57) ABSTRACT

A thermal management system for a motor vehicle includes an electric machine with a motor cooling circuit for removing heat from or supplying heat to the electric machine, a battery with a battery cooling circuit for removing heat from or supplying heat to the battery, a passenger compartment with an air conditioning circuit for removing heat from or supplying heat to the passenger compartment, a brake with a brake cooling circuit for removing heat from or supplying heat to the brake, and a hydraulic control system. The hydraulic control system has a first hydraulic switching element arranged to vary a volumetric flow rate in the motor cooling circuit, the battery cooling circuit, the air conditioning circuit or the brake cooling circuit.

### CROSS-REFERENCE TO RELATED APPLICATIONS

This application is the United States National Phase of PCT Appln. No. PCT/DE2023/100835 filed Nov. 8, 2023, which claims priority to German Application No. DE102022131333.6 filed Nov. 28, 2022, the entire disclosures of which are incorporated by reference herein.

### TECHNICAL FIELD

The present disclosure relates to a thermal management system for an electrically operated motor vehicle having an electric machine with a motor cooling circuit for removing heat from or supplying heat to the electric machine, a battery with a battery cooling circuit for removing heat from or supplying heat to the battery, a passenger compartment with a passenger compartment air-conditioning circuit for removing heat from or supplying heat to the passenger compartment, a hydraulic control system for influencing the volumetric flow rates in the motor cooling circuit and/or the battery cooling circuit and/or the passenger compartment air-conditioning circuit by means of at least one hydraulic switching element each, and an electronic control unit for controlling the at least one hydraulic switching element of the hydraulic control system.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found by way of example in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor arranged coaxially to a bevel gear differential.

In vehicles with this type of electric drive, the heating and cooling system for the passenger compartment is the largest secondary energy consumer, as the combustion engine is generally not used as a heat supplier in fully electric drive concepts. There are also additional temperature control requirements for drive components, such as the battery, the power electronics and the electric drive unit itself.

The ambient temperature limiting condition can lead to a considerable loss of range in vehicles with an electric drive unit. Depending on the situation, it can happen that the temperature control system consumes more electrical energy than is required to drive the vehicle. The energy efficiency of heating and cooling systems for fully electric motor vehicles is therefore increasingly the focus of development efforts.

In addition to heating the passenger compartment, preconditioning the battery by heating, which is necessary for an upcoming fast-charging phase, is one of the most energy-intensive thermal management functions. A generic thermal management system consisting of a coolant circuit with two circuits is described in U.S. Pat. No. 8,402,776, for example. Another example of such a thermal management system can be found in DE102012208992A1. The energy-intensive and therefore range-reducing heating of the coolant or the interior air of the passenger compartment via auxiliary heaters is generally undesirable.

### SUMMARY

The present disclosure provides an improved thermal management system for an electrically operated motor vehicle.

The thermal management system for an electically operated motor vehicle includes an electric machine with a motor cooling circuit for removing heat from or supplying heat to the electric machine, a battery with a battery cooling circuit for removing heat from or supplying heat to the battery, a passenger compartment with a passenger compartment air-conditioning circuit for removing heat from or supplying heat to the passenger compartment, a hydraulic control system for influencing the volumetric flow rates in the motor cooling circuit and/or the battery cooling circuit and/or the passenger compartment air-conditioning circuit by means of at least one hydraulic switching element each, and an electronic control unit for controlling the at least one hydraulic switching element of the hydraulic control system. The thermal management system also has a brake with a brake cooling circuit for removing heat from or supplying heat to the brake, and the hydraulic control system acts on the brake cooling circuit by means of at least one hydraulic switching element in order to influence the volumetric flow rate in the brake cooling circuit.

The brake of an electrically operated motor vehicle can be used as a heat source for the thermal management system and integrated into this. Brakes equipped with a thermal energy recovery device are used for this purpose.

The individual elements will be explained first, after which example embodiments of the subject matter will be described.

A hydraulic control system directs the volumetric flow rates within a thermal management system of a motor vehicle by means of switching elements that act hydraulically on a fluid, such as valves, slides, pumps and the like. The hydraulic control system can, for example, completely or partially throttle a volumetric flow rate and/or distribute it to the relevant heat sources and sinks in sub-circuits of the thermal management system of a motor vehicle. For this purpose, the hydraulic switching elements are controlled and switched by the electronic control unit.

A hydraulic switching element can be a hydraulic pump, a switching valve, a controllable throttle valve and the like. A hydraulic switching element can be electrically controlled. Furthermore, a hydraulic switching element may have at least two different, switchable operating states in which the hydraulic switching element acts in different ways on the corresponding fluid in a circuit.

The brake of the thermal management system according to the disclosure has the function of braking a shaft to be braked, for example by means of a frictional connection. In particular, the brake can be based on the functional principle of a dry or wet multi-disc brake, a disc brake or a drum brake.

Furthermore, a brake can also have a brake actuator. In particular, a brake actuator has the function of activating the brake, i.e. setting it to a friction-fit operating state and an operating state released from the frictional connection. In particular, the brake actuator can be actuated pneumatically, hydraulically, by an electric motor, mechanically, electromagnetically or by any combination of these. The brake actuator can have at least one linear displaceable piston, which may be displaceable in the axial direction.

The brake may be arranged in a brake housing. The brake housing encloses the brake. A brake housing can also accommodate one or more brake actuators. The brake housing can furthermore be part of a cooling system, and can be designed in such a way that cooling fluid can be supplied to the brake system via the brake housing and/or the heat can be dissipated to the outside via the housing surfaces. The brake housing also protects the brake from external mechanical and/or chemical influences. A brake housing can be formed in particular from a metallic material. The brake housing can be formed from a metallic cast material, such as gray cast iron or cast steel. In principle, it is also conceivable to form the brake housing entirely or partially from a plastic. Furthermore, it is possible for the brake housing to be designed in one piece or in several parts.

The brake housing can also be designed completely or partially as part of a motor housing of an electric machine or a transmission housing of a transmission coupled to the electric machine. The brake housing and the motor housing or the transmission housing may form a single structural unit. For example, the brake housing can be bolted to the motor housing or the transmission housing. The brake housing may be designed in such a way that dust generated during braking cannot escape from the brake housing. This prevents unwanted pollution of the environment with brake dust. Braking noise can also be reduced by encapsulating the brake system in this way. Here, the braking performance of the brake system is independent of the weather conditions outside the motor vehicle.

The brake can be designed as a disc brake. The brake disc is the rotating part of a disc brake, on the end faces of which the brake shoes act releasably in order to decelerate the rotary movement of the brake disc by means of frictional connection during operation of the disc brake. The brake disc may have a brake disc body.

Brake discs can be formed from a cast metal, in particular gray cast iron, ductile cast iron or cast steel, and then may be machined by turning and/or milling. It is also possible to use silicon carbide reinforced with carbon fibers and/or a carbon fiber-reinforced ceramic material in order to achieve a low brake disc weight. It is also conceivable, especially for a cost-effective provision of a brake disc, to punch it out of a sheet.

A brake disc may have a hollow cylindrical spatial shape the axial extension of which is smaller than its diameter. The brake disc can be made in one part or in several parts. In the case of a multi-piece brake disc, the individual brake disc elements can be arranged in layers in the axial direction, resulting in a kind of sandwich construction.

The brake disc body is the part of the brake disc on which the brake shoes act with friction to reduce the rotational speed of the brake disc. The brake disc body can have a plurality of brake disc cooling channels, which can be used in particular to dissipate heat and/or brake dust from the brake disc body.

Furthermore, the brake system can have a shaft connection. The shaft connection of the brake disc connects the brake disc body with the rotating shaft to be braked, which is also referred to as the brake shaft. The shaft connection can be designed as a separate component that is arranged in the torque flow between the brake disc body and the shaft to be braked or as a connection between the brake disc body and the shaft to be braked. It is thus possible for the shaft to be braked and the shaft connection to be formed in one piece, in particular monolithically. In principle, it is also conceivable that the shaft connection and the brake disc body are designed as one piece. The shaft to be braked, the shaft connection and the brake disc body may be formed in one piece, in particular monolithically. The shaft connection can also be produced, for example, by means of positive locking, frictional locking and/or material locking between the shaft to be braked and the brake disc body. For example, the shaft connection can be made by means of a press fit, splines or welding.

The disc brake can have a hydraulic brake disc cooling system. A hydraulic brake disc cooling system uses a brake disc cooling fluid to cool the brake disc. In this case, the brake disc cooling fluid can act on the brake disc at least in sections and/or be fed through the brake disc. The hydraulic brake disc cooling system may be designed in such a way that the brake disc cooling fluid cannot reach the friction surfaces between the brake shoes and the brake disc body.

For this purpose, the hydraulic brake disc cooling system can have at least one, or a plurality of, brake disc cooling channels in which the brake disc cooling fluid is guided.

The hydraulic brake disc cooling system may be connected to a brake disc cooling circuit, within which the frictional heat absorbed by the brake disc cooling fluid is dissipated from the disc brake and fed to a heat sink, such as a heat exchanger. The brake disc cooling circuit can form part of the brake cooling circuit of the thermal management system. The brake disc cooling circuit may be the brake cooling circuit of the thermal management system.

To create a frictional connection between the brake shoes and the brake disc, the brake shoes, in particular with their brake shoe friction linings, may be pressed axially against the brake disc by means of a brake actuator.

The brake is intended for a motor vehicle that can be driven electrically by means of an electric machine. Electric machines within the meaning of this application are used to convert electrical energy into mechanical energy and/or vice versa, and usually have a stationary part referred to as a stator or stationary anchor, and a part referred to as a rotor or runner and arranged to be movable relative to the stationary part. In connection with the present disclosure, an electric machine can be designed in particular as a rotary machine. With such electric rotary machines, a distinction is made in particular between radial flux machines and axial flux machines. In a radial flux machine, the magnetic field lines extend in the radial direction in the air gap formed between rotor and stator, while in the case of an axial flux machine the magnetic field lines extend in the axial direction in the air gap formed between rotor and stator.

In the context of the present disclosure, an electric machine is intended in particular for use within a drive train of a hybrid or fully electrically powered motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW, or more than 70 kW. Furthermore, the electric machine may provide speeds greater than 5,000 rpm, greater than 10,000 rpm, or greater than 12,500 rpm.

The electric machine can have a housing, also known as a motor housing. The motor housing encloses the electric machine. A motor housing can also accommodate the control and power electronics, and, for example, also at least parts of the brake system. The motor housing can furthermore be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics that can be present from external mechanical and/or chemical influences.

A motor housing of the electric machine can be formed in particular from a metallic material. The motor housing can be formed from a metallic cast material, such as gray cast iron or cast steel. In principle, it is also conceivable to form the motor housing entirely or partially from a plastic. Furthermore, it is possible for the motor housing of the electric machine to be designed in one piece or in several parts.

A rotor is the spinning (rotating) part of an electric machine. The rotor has a rotor shaft and one or more rotor bodies formed of rotor lamination stacks which are non-rotatably arranged on the rotor shaft. The rotor shaft can be hollow, which firstly results in weight savings and secondly allows the supply of lubricant or coolant to the rotor body. In particular, the rotor shaft can be coupled to the brake shaft of the brake system.

The electric machine can be coupled to a transmission, which is designed to generate a drive torque for the motor vehicle. The drive torque may be a main drive torque, so that the motor vehicle is driven exclusively by the drive torque.

In particular, it may be provided that the electric machine and the transmission are arranged in a shared drive train housing. Alternatively, it would of course also be possible for the electric machine to have a motor housing and the transmission to have a transmission housing, wherein the structural unit can then be brought about by fixing the transmission assembly in relation to the electric machine. This structural unit is sometimes also referred to as an e-axle. The drive train housing may be formed from a metallic material, e.g., from aluminum, gray cast iron or cast steel, in particular by means of a primary shaping process such as casting or die-casting. In principle, however, it would also be possible to form the drive train housing from a plastic material. The drive train housing can have a cup-like basic shape, such that the electric machine and the transmission can be inserted into the drive train housing via the open end face thereof.

The electric machine may have a motor housing and/or the transmission may have a transmission housing, wherein the structural unit can then be implemented by fixing the transmission in relation to the electric machine. The transmission housing is a housing for accommodating a transmission. It has the task of guiding existing shafts via the bearings and giving the wheels (cam discs, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing may be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

Furthermore, the transmission can be configured as a planetary gear or comprise a planetary gear. The planetary gear can have a sun gear and several planetary gears meshing with the sun gear and rotatably mounted in a planetary gear carrier, which rotate around the sun gear, as well as a ring gear arranged to be coaxial to the sun gear, in which the planetary gears roll.

Furthermore, the transmission can have a differential transmission. A differential transmission is a planetary gear with one drive and two outputs. It usually has the function of driving two vehicle wheels of a motor vehicle in such a way that they can turn at different speeds when cornering, but with the same propulsive force.

To realize different drive or operating modes for the motor vehicle, one or more separating clutches can be provided within the torque path between the electric machine and a vehicle wheel. A separating clutch can be arranged between the output of the electric machine and the input of the transmission, for example, so that the electric machine can be decoupled from the transmission, allowing the motor vehicle to be operated in coasting mode. It would also be conceivable to arrange a separating clutch between the output of the transmission and a vehicle wheel or the vehicle wheels, also allowing the motor vehicle to be operated in coasting mode. Finally, it is also possible to arrange a separating clutch between the input of the brake system and the output of the electric machine, which allows the brake system to be completely decoupled from the electric machine.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

Example embodiments are also specified. The features listed individually can be combined with one another in a technologically meaningful manner and can define further embodiments. In addition, the features are specified and explained in more detail in the description, wherein further embodiments are shown.

According to an example embodiment, it can be provided that the thermal management system also comprises a inverter with an inverter cooling circuit for removing heat from or supplying heat to the inverter, and the hydraulic control unit acts on the inverter cooling circuit by means of at least one hydraulic switching element in order to influence the volumetric flow rates in the inverter cooling circuit.

The electric machine for driving the motor vehicle can be energized by means of an inverter. The power electronics of the inverter may be housed in an inverter housing. The inverter housing may be formed from a metallic material, e.g., from aluminum, gray cast iron or cast steel, in particular by means of a primary shaping process such as casting or die-casting. The inverter housing may have a pot-like spatial shape. In this context, the housing cover can be inserted into the pot-like inverter housing. Alternatively, it would also be conceivable for the housing cover to rest on the pot-like inverter housing and cover its opening. The inverter housing can also be part of the motor housing of an electric machine or vice versa. This means that the inverter housing is formed completely or partially integral, in particular monolithic, with the motor housing.

The power electronics unit received in the inverter housing can be provided in particular for an electric machine for driving a motor vehicle. The power electronics unit may be a combination of different components that control or regulate a current to the electric machine of the axle drive train, e.g., including the peripheral components required for this purpose, such as cooling elements or power supply units. In particular, the power electronics unit contains one or more power electronics components that are configured to control or regulate a current. These may be one or more power switches, such as power transistors. The power electronics system may have more than two, e.g., three, phases or current paths which are separate from one another and which each have at least one separate power electronics component. The power electronics system may be designed for the open-loop or closed-loop control of a power per phase with a peak power, e.g., a continuous power, of at least 10 W, at least 100 W, or at least 1000 W. The power electronics may also have a control unit, for example in the form of control electronics and/or sensor electronics, for the electric machine.

According to a further development, it can also be provided that the brake cooling circuit is coupled with the inverter cooling circuit via a first heat exchanger.

Furthermore, according to an example embodiment, it can be provided that the motor cooling circuit is coupled with the inverter cooling circuit via a second heat exchanger.

According to a further embodiment, it can be provided that the battery cooling circuit is coupled with the passenger compartment air-conditioning circuit via a third heat exchanger.

Furthermore, the disclosure can also be further developed in such a way that the brake cooling circuit is designed with the motor cooling circuit in such a way that the brake and the electric machine are arranged in a common cooling circuit.

In an example embodiment, it can also be provided that a hydraulic switching element is arranged in the common cooling circuit for influencing the volumetric flow rates directed to the brake and to the electric machine, which allows the thermal management within this sub-circuit to be further optimized.

In an example embodiment, a first ambient heat transfer unit is arranged in the brake cooling circuit, which can also contribute to improved thermal management.

According to a further embodiment, it can be provided that the brake cooling circuit is designed with the inverter cooling circuit in such a way that the brake and the inverter are arranged in a common cooling circuit.

The hydraulic control unit may further include a distribution device, to which the motor cooling circuit and/or the battery cooling circuit and/or the brake cooling circuit and/or the inverter cooling circuit are connected, wherein the distribution device is configured to connect two or more cooling circuits to each other.

### BRIEF DESCRIPTION OF THE DRAWINGS

The present disclosure is explained in more detail below with reference to figures without limiting the general concept of the disclosure.

In the figures:

FIG. 1 shows an electrically operated motor vehicle with a thermal management system in a schematic block diagram view,

FIG. 2 shows a first embodiment of a thermal management system for an electrically operated motor vehicle in a schematic hydraulic circuit diagram,

FIG. 3 shows a second embodiment of a thermal management system for an electrically operated motor vehicle in a schematic hydraulic circuit diagram,

FIG. 4 shows a third embodiment of a thermal management system for an electrically operated motor vehicle in a schematic hydraulic circuit diagram,

FIG. 5 shows a fourth embodiment of a thermal management system for an electrically operated motor vehicle in a schematic hydraulic circuit diagram,

FIG. 6 shows a fifth embodiment of a thermal management system for an electrically operated motor vehicle in a schematic hydraulic circuit diagram,

FIG. 7 shows a sixth embodiment of a thermal management system for an electrically operated motor vehicle in a schematic hydraulic circuit diagram,

FIG. 8 shows a seventh embodiment of a thermal management system for an electrically operated motor vehicle in a schematic hydraulic circuit diagram, and

FIG. 9 shows a eighth embodiment of a thermal management system for an electrically operated motor vehicle in a schematic hydraulic circuit diagram.

### DETAILED DESCRIPTION

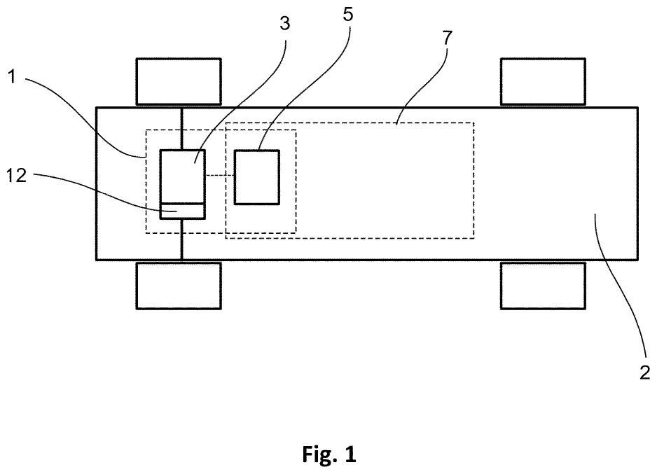

FIG. 1 shows a thermal management system 1 for an electrically operated motor vehicle 2.

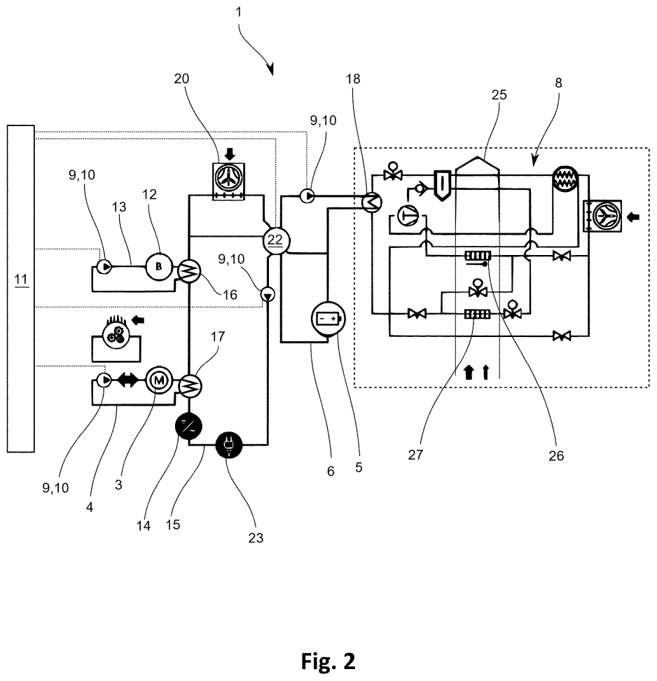

FIG. 2 shows a first embodiment of a thermal management system 1. It includes an electric machine 3 with a motor cooling circuit 4 for removing heat from or supplying heat to the electric machine 3, a battery 5 with a battery cooling circuit 6 for removing heat from or supplying heat to the battery 5, and a passenger compartment 7 with a passenger compartment air-conditioning circuit 8 for removing heat from or supplying heat to the passenger compartment 7.

In addition to these fluid circuits, the thermal management system 1 also includes a hydraulic control system 9 for influencing the volumetric flow rates in the motor cooling circuit 4, the battery cooling circuit (6) and the passenger compartment air-conditioning circuit 8 by means of one hydraulic switching element 10 each, which in the case shown is a hydraulic pump.

These hydraulic switching elements 10 are controlled by an electronic control unit 11.

The thermal management system 1 also includes a brake 12 with a brake cooling circuit 13 for removing heat from or supplying heat to the brake 12. The hydraulic control system 9 acts on the brake cooling circuit 13 by means of at least one hydraulic switching element 10 in order to influence the volumetric flow rate in the brake cooling circuit 13. This switching element 10 is also designed as a hydraulic pump, as can be seen from the corresponding circuit diagram.

Furthermore, FIG. 2 shows that the thermal management system 1 also has an inverter 14 with an inverter cooling circuit 15 for removing heat from or supplying heat to the inverter 14. The hydraulic control system 9 acts on the inverter cooling circuit 15 by means of at least one hydraulic switching element 10 in order to influence the volumetric flow rates in the inverter cooling circuit 15. The hydraulic switching element 10 in the inverter cooling circuit 15 is also designed as a hydraulic pump.

In the embodiment shown in FIG. 2, the brake cooling circuit 13 is coupled to the inverter cooling circuit 15 via a first heat exchanger 16. The motor cooling circuit 4 is also coupled in a similar manner to the inverter cooling circuit 15 via a second heat exchanger 17. FIG. 1 also shows that the battery cooling circuit 6 is coupled to the passenger compartment air-conditioning circuit 8 via a third heat exchanger 18.

The hydraulic control system 9 also includes a distribution device 22, to which the battery cooling circuit 6 and the inverter cooling circuit 15 are connected, and the distribution device 22 is configured to connect at least the two cooling circuits 6, 15 to each other.

An on-board charger 23, and the inverter 14 are also connected in series in the inverter cooling circuit 15. The second heat exchanger 17 of the separated motor cooling circuit 4 of the electric machine 3 is arranged downstream of the inverter cooling circuit 15 in the same sub-circuit of the thermal management system 1.

Heat can be exchanged between the battery cooling circuit 6 and the passenger compartment air-conditioning circuit 8 via the third heat exchanger 18. Here, the passenger compartment air-conditioning circuit 8 at the third heat exchanger 18 and the battery cooling circuit 6 are switchably connected. This enables both heating and cooling of the battery 5 intended to power the electric machine 3. An ambient heat transfer unit 20, which enables heat to be transferred to the environment, is also arranged in the inverter cooling circuit 15. This provides two ways of lowering the temperature of the inverter cooling circuit 15, namely via the ambient heat transfer unit 20 and via the third heat exchanger 18 by means of the passenger compartment air-conditioning circuit 8. To heat the interior air in the passenger compartment 7, a heating element 26 with a heating heat exchanger is arranged in the air flow 25 of the interior ventilation, which converts electrical energy into thermal energy. The air flow 25 of the interior ventilation is cooled via a cooling heat exchanger 27, which is also arranged directly in the air flow 25.

FIGS. 2 to 9 show arrangements of a thermal management system 1 for electrically operated motor vehicles 2 having a brake 12 as the heat source. FIGS. 2-9 each show variants of a thermal management system 1 with different arrangements of a brake 12 as a heat source and corresponding options for transferring the thermal energy, for example to the air flow 25 of the interior ventilation.

FIG. 2 shows an embodiment of the thermal management system 1, which depicts the “heat source” brake 12 in the thermal management system 1 of a motor vehicle 2. In this case, the on-board charger 23, the inverter 14 with the power electronics for supplying power to the electric machine 3, the second heat exchanger and the first heat exchanger 16 are connected in series in a sub-circuit, which is referred to as the inverter cooling circuit 15, starting from the hydraulic switching element 10, which is designed as a hydraulic pump, in the direction of flow of the fluid. The heat source brake 12 is arranged in a separate brake cooling circuit 13 in conjunction with a hydraulic switching element 10 designed as a hydraulic pump, which is coupled to the inverter cooling circuit 15 via the first heat exchanger 16. In particular, this also allows the use of a brake cooling fluid in the brake cooling circuit 13, which differs in its material composition from the inverter cooling fluid used in the inverter cooling circuit 15. An ambient heat transfer unit 20 and the third heat exchanger 18 are arranged as permanent heat sinks in sub-circuits of the inverter cooling circuit 15. These can be switched on and off via the distribution device 22.

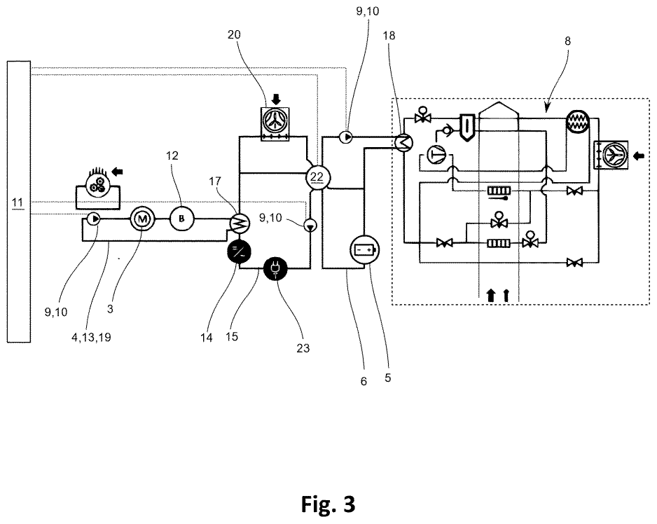

FIG. 3 shows an embodiment of the thermal management system 1 in which the brake cooling circuit 13 is designed with the motor cooling circuit 4 in such a way that the brake 12 and the electric machine 3 are arranged in a common cooling circuit 19. The brake 12 is arranged so that the coolant flows through it after the electric machine 3 and is connected in series. A hydraulic switching element 10 designed as a hydraulic pump is provided to supply the volumetric flow rate of coolant in the common cooling circuit 19. The heat energy is exchanged into the inverter cooling circuit 15 via the heat exchanger 17. This requires the use of a coolant in the common cooling circuit 19, the material composition of which is equally compatible with the requirements of the brake 12 and the requirements of the electric machine 3.

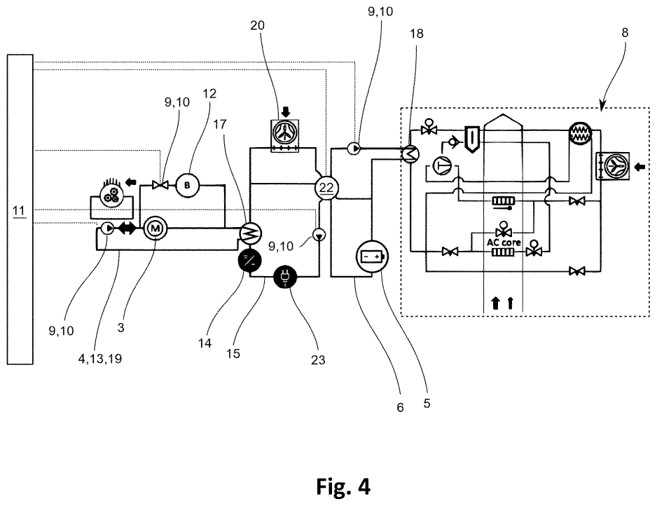

A variation of the configuration of a thermal management system 1 known from FIG. 3 is shown in FIG. 4. Here too, the brake 12 is located in the common coolant circuit 19 with the electric machine 3. After the switching element 10, which is designed as a hydraulic pump, the volumetric flow rate of the coolant is distributed—the brake 12 is arranged parallel to the electric machine 3. The volumetric flow rate of the coolant can be switched on or off via the switching element 10 of the hydraulic control system 9, which is designed as a switching valve. A hydraulic switching element 10 is thus arranged in the common cooling circuit 19 for influencing the volumetric flow rates directed to the brake 12 and to the electric machine 3.

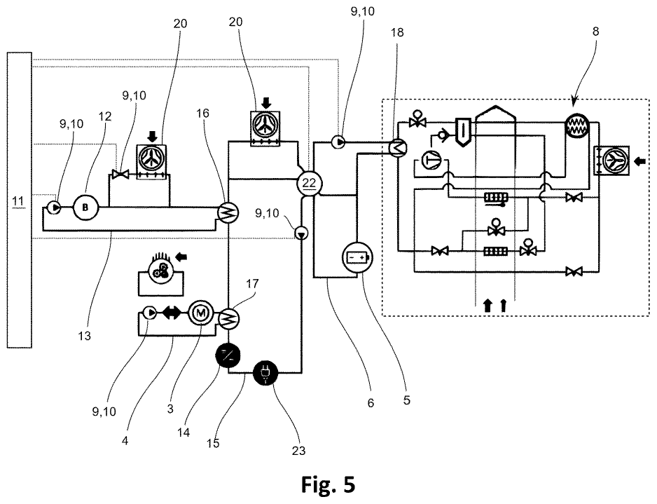

The embodiment of the thermal management system 1, as shown in FIG. 5, corresponds in principle to the arrangement 1 shown in FIG. 2, but is extended by an additional ambient heat transfer unit 20 in the brake cooling circuit 13. This is arranged in such a way that it can be switched to bypass via the switching element 10, which is designed as a switching valve, as long as the thermal energy of the brake 12 can be fully absorbed by the brake cooling circuit 13.

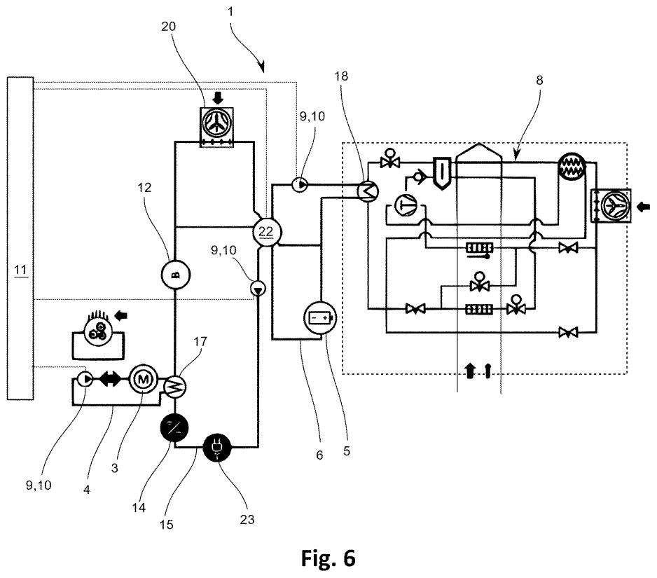

In the version of the thermal management system 1 shown in FIG. 6, the brake 12 is arranged directly in the inverter cooling circuit 15. In other words, the brake cooling circuit 13 is designed with the inverter cooling circuit 15 in such a way that the brake 12 and the inverter 14 are arranged in a common cooling circuit. The arrangement is such that the coolant first flows through the on-board charger 23, then through the inverter 14 with the power electronics, then through the heat exchanger 17 of the motor cooling circuit 4 and only then through the brake 12. This requires the use of a coolant in the inverter cooling circuit 15, the material composition of which equally corresponds with the requirements of the brake 12 and the requirements of the rest of the inverter cooling circuit 15.

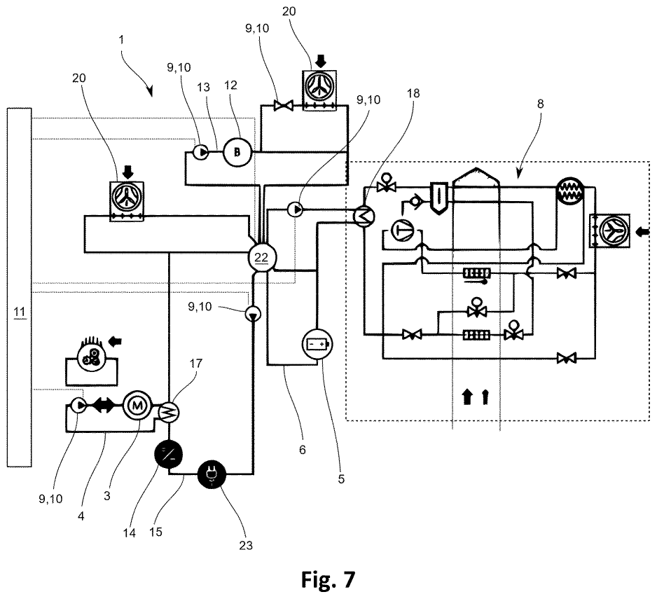

In the embodiment shown in FIG. 7, the thermal management system 1 is extended by a further sub-circuit, namely the brake cooling circuit 13, in which a switching element 10 configured as a hydraulic pump is arranged next to one or more brakes 12. The brake cooling circuit 13 is controlled via the distribution device 22. Here too, the requirements of the brake 12 and the other components that can be exposed to this coolant must be taken into account with regard to the material composition of the coolant used.

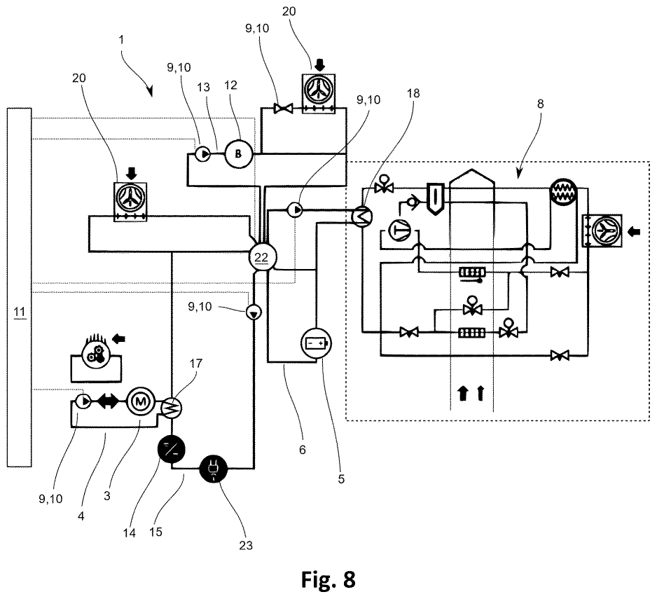

An extension of the embodiment in FIG. 7 is shown in FIG. 8, in which an ambient heat transfer unit 20 that can be switched on via the switching element 10 is arranged in parallel in the brake cooling circuit 13. This allows the brake 12 to be used even if no further thermal energy can be absorbed by the brake cooling circuit 13.

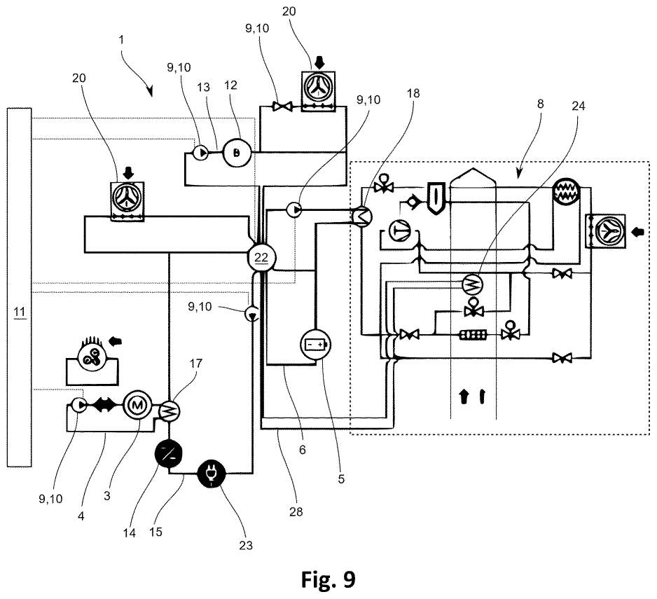

In the design variant shown in FIG. 9, a heat exchanger 24 is arranged in the air flow 25 of the interior ventilation system. This exchanges the heat directly from the coolant circuit 28 with the air flow 25. The coolant circuit 28 is connected to the distribution device 22 and can be switched on or off by it.

The present disclosure is not limited to the embodiments shown in the figures. The above description is therefore not to be regarded as limiting, but rather as illustrative. The following claims are to be understood as meaning that a stated feature is present in at least one embodiment of the invention. This does not exclude the presence of further features. Where the claims and the above description define “first” and “second” features, this designation serves to distinguish between two features of the same type without defining an order of precedence.

### REFERENCE NUMERALS

1 Thermal management system
2 Motor vehicle
3 Electric machine
4 Motor cooling circuit
5 Battery
6 Battery cooling circuit
7 Passenger compartment
8 Passenger compartment air-conditioning circuit
9 Hydraulic control system
10 Switching element
11 Electronic control unit
12 Brake
13 Brake cooling circuit
14 Inverter
15 Inverter cooling circuit
16 Heat exchanger
17 Heat exchanger
18 Heat exchanger
19 Cooling circuit
20 Ambient heat transfer unit
22 Distribution device
23 On-board charger
24 Heat exchanger
25 Air flow
26 Heating element
27 Cooling heat exchanger
28 Coolant circuit

1. A thermal management system for an electrically operated motor vehicle comprising
an electric machine with a motor cooling circuit for removing heat from or supplying heat to the electric machine,
a battery with a battery cooling circuit for removing heat from or supplying heat to the battery,
a passenger compartment with a passenger compartment air-conditioning circuit for removing heat from or supplying heat to the passenger compartment,
a hydraulic control system for influencing the volumetric flow rates in the motor cooling circuit or the battery cooling circuit or the passenger compartment air-conditioning circuit by means of at least one hydraulic switching element each,
an electronic control unit for controlling the at least one hydraulic switching element of the hydraulic control system,
wherein:
the thermal management system also comprises a brake with a brake cooling circuit for removing heat from or supplying heat to the brake, wherein the hydraulic control system acts on the brake cooling circuit by means of the at least one hydraulic switching element in order to influence the volumetric flow rate in the brake cooling circuit.

2. The thermal management system according to claim 1, wherein:
the thermal management system also comprises a inverter with an inverter cooling circuit for removing heat from or supplying heat to the inverter, wherein the hydraulic control system acts on the inverter cooling circuit by means of the at least one hydraulic switching element in order to influence the volumetric flow rates in the inverter cooling circuit.

3. The thermal management system according to claim 2,
wherein:
the brake cooling circuit is coupled to the inverter cooling circuit via a first heat exchanger.

4. The thermal management system according to claim 2,
wherein:
the motor cooling circuit is coupled to the inverter cooling circuit via a second heat exchanger.

5. The thermal management system according to claim 1,
wherein:
the battery cooling circuit is coupled to the passenger compartment air-conditioning circuit via a third heat exchanger.

6. The thermal management system according to claim 1,
wherein:
the brake cooling circuit is designed with the motor cooling circuit in such a way that the brake and the electric machine are arranged in a common cooling circuit.

7. The thermal management system according to claim 6, wherein:
the hydraulic switching element is arranged in the common cooling circuit for influencing the volumetric flow rates directed to the brake and to the electric machine.

8. The thermal management system according to claim 1,
wherein:
a first ambient heat transfer unit is arranged in the brake cooling circuit.

9. The thermal management system according to claim 2,
wherein:
the brake cooling circuit is designed with the inverter cooling circuit in such a way that the brake and the inverter are arranged in a common cooling circuit.

10. The thermal management system according to claim 2,
wherein:
the hydraulic control system further comprises a distribution device, to which the motor cooling circuit or the battery cooling circuit or the brake cooling circuit or the inverter cooling circuit is connected, wherein the distribution device is configured to connect two or more cooling circuits to each other.

11. A thermal management system for a motor vehicle, comprising:
an electric machine comprising a motor cooling circuit for removing heat from or supplying heat to the electric machine;
a battery comprising a battery cooling circuit for removing heat from or supplying heat to the battery;
a passenger compartment comprising an air conditioning circuit for removing heat from or supplying heat to the passenger compartment;
a brake comprising a brake cooling circuit for removing heat from or supplying heat to the brake; and
a hydraulic control system comprising a first hydraulic switching element arranged to vary a volumetric flow rate in the motor cooling circuit, the battery cooling circuit, the air conditioning circuit or the brake cooling circuit.

12. The thermal management system of claim 11 further comprising an inverter comprising an inverter cooling circuit for removing heat from or supplying heat to the inverter, wherein the hydraulic control system further comprises a second hydraulic switching element arranged to vary a volumetric flow rate in the inverter cooling circuit.

13. The thermal management system of claim 12, wherein the brake cooling circuit is coupled to the inverter cooling circuit via a first heat exchanger.

14. The thermal management system of claim 12, wherein the motor cooling circuit is coupled to the inverter cooling circuit via a second heat exchanger.

15. The thermal management system of claim 12, wherein the battery cooling circuit is coupled to the air conditioning circuit via a third heat exchanger.

16. The thermal management system of claim 11, wherein the brake cooling circuit and the motor cooling circuit are combined in a common cooling circuit.

17. The thermal management system of claim 16, wherein the first hydraulic switching element is arranged to vary a volumetric flow rate in the common cooling circuit.

18. The thermal management system of claim 11, further comprising a first ambient heat transfer unit arranged in the brake cooling circuit.

19. The thermal management system of claim 12, wherein the brake cooling circuit and the inverter cooling circuit are combined in a common cooling circuit.

20. The thermal management system of claim 12 further comprising a distribution device arranged to connect two of the motor cooling circuit, the battery cooling circuit, the brake cooling circuit or the inverter cooling circuit together.
